(19) United States
(12) Patent Application Publication
(10) Pub. No.: US 2007/0150942 A1
(43) Pub. Date: Jun. 28, 2007

(54) Centralized identity verification and/or password validation

(76) Inventor: Brian R. Cartmell, Mercer Island, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/317,568

(22) Filed: Dec. 23, 2005

(51) Int. Cl. H04L 9/32

(52) U.S. Cl. 726/5

(57) ABSTRACT

Described is a system and method for validating a user's login information. A provider (e.g. a provider of goods and/or services) receives a login request from a customer that includes a token value. The provider passes the token value to a centralized identity verifier with which the customer is registered. The centralized identity verifier tests the token value and returns a notice of the results of the test to the provider.

### BACKGROUND

Computer security and privacy have become enormously important to many people. Many people are concerned that their confidential data may be compromised through conventional computer system login methods, such as ordinary login name/password pairs. Strong, two-factor authentication provides a higher level of security than solutions based on static passwords alone. These systems help prevent identity theft; allow networks to be opened to partners, suppliers, and customers; and protect user devices and Web services. However, managing disparate, often-proprietary authentication mechanisms—e.g., digital certificates, dynamic One Time Passwords (OTPs), and USB tokens—can be costly and complex. Besides eroding hardware and infrastructure budgets, proprietary or piecemeal authentication solutions can be difficult to integrate and often scale poorly, limiting opportunities for expansion and collaboration.

Unfortunately, an adequate identity verification solution has eluded those skilled in the art, until now.

### SUMMARY

The present invention is directed at a system and method for validating a user login event through the use of a centralized verifier. Briefly stated, a provider (e.g. a provider of goods and/or services) receives a login request from a customer that includes a token value. The provider passes the token value to a centralized identity verifier with which the customer is registered. The centralized identity verifier tests the token value and returns a notice of the results of the test to the provider.

### BRIEF DESCRIPTION OF THE DRAWINGS

FIG. 1 is a conceptual overview of a system for centrally verifying the identify of a user to one of a plurality of disparate providers.

FIG. 2 is a functional block diagram illustrating in slightly greater detail one implementation of the verifier introduced in FIG. 1.

FIG. 3 is a functional block diagram illustrating in slightly greater detail one implementation of the provider introduced in FIG. 1.

FIG. 4 is a functional block diagram illustrating in slightly greater detail one implementation of the customer introduced in FIG. 1.

FIG. 5 is a conceptual illustration of a login page that may be presented to the customer by the provider.

FIG. 6 is an operational flow diagram generally illustrating a process performed by a customer to register himself/itself with a centralized identity verifier.

FIG. 7 is an operational flow diagram generally illustrating a process performed by a customer to register himself/itself with the provider.

FIG. 8 is an operational flow diagram generally illustrating a process performed by a provider to have the identity of a customer verified by a verifier.

FIG. 9 is an operational flow diagram generally illustrating a process for verifying the identity of a customer in response to a request by a provider.

### DETAILED DESCRIPTION

Generally stated, the invention envisions a centralized verification mechanism that enables users to have their identities verified by any of a number of participating providers. In one specific embodiment, the centralized password repository makes use of “tokens” to verify the identity of the user.

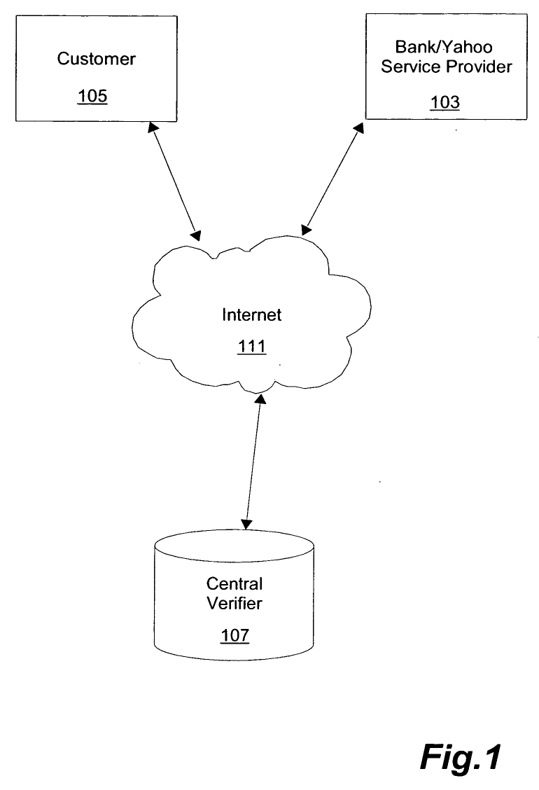

FIG. 1 is a conceptual overview of a system 100 for centrally verifying the identify of a user to one of a plurality of disparate providers. In this particular example, a provider 103 makes goods or services available to its customers, such as customer 105. The provider 103 may be any entity that provides goods or services to customers and requires an authentication of those customers. The customer 105 is any entity that transacts with the provider 103 and likely many other providers (not shown).

One classic example of the described relationship is in the area of electronic commerce. In such an example, the customer 105 may be an individual using a general purpose computing system, and the provider 103 may be an online merchant with which the customer 105 does business. As is typical with online merchants, the customer 105 has an account with the provider 103. Because the customer 105 may be conducting financial or other sensitive transactions with the provider 103, the customer 105 is required to login at a site maintained by the provider 103. In conventional technology, the provider 103 maintains a data store that associates user logins with passwords. The customer 105 is required to provide both the customer login and password to authenticate the customer 105 to the provider 103.

However, in accordance with this implementation of the invention, the provider 103 and the customer 105 make use of a central verifier 107 to perform the authentication task. In this implementation, the customer 105 creates an account with the central verifier 107, and the central verifier 107 provides the customer 105 with a mechanism that enables the customer 105 to be uniquely identified to the verifier 107.

The provider 103 also creates a relationship with the verifier 107 so that the provider 103 can take advantage of the verifier's authentication technology. In particular, the provider 103 allows customers, such as customer 105, to create provider accounts that include authentication by the verifier 107. When the customer 105 logs in at the provider's site, the customer 105 uses the mechanism provided by the verifier 107 to login. The provider 103 may pass information collected during that login process to the verifier 107 for verification. If successful, the verifier 107 informs the provider 103 that the customer 105 has been verified, and the provider 103 may then transact with the customer 105 with confidence.

In this particular embodiment, each of the parties communicate over a publicly accessible network 111, such as the Internet. However, the techniques and mechanisms described here have equal applicability using other communications mechanisms, such as private or enterprise networks, combinations of private and public networks, wireless communication such as a cellular telecommunications network, or even human interaction such as human conversations perhaps conducted over a telephone system. It will be appreciated that the teachings of the invention are not limited to the particular implementations described in this document.

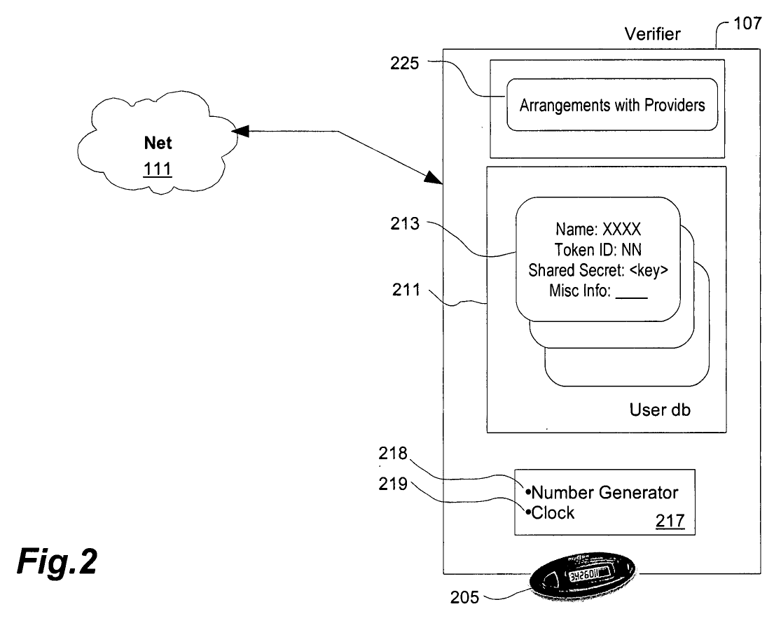

FIG. 2 is a functional block diagram illustrating in slightly greater detail one implementation of the verifier 107. In this implementation, the verifier 107 may include a general purpose computing system or systems with appropriate programming to perform the tasks and functions described. The verifier 107 is coupled to the network 111 to support communications with other devices, such as the customer and the provider.

As mentioned above, the verifier 107 provides the service of authenticating its users (e.g., customer 105) to third-party providers (e.g., provider 103). For the purpose of this document, the term “user” refers to the entity or individual whose identity or information is being authenticated, and the term “provider” refers to any entity or individual to which the authentication is provided. However, these are but concepts and the particular terminology used to identify each party is of no consequence to the more broad teachings of the invention.

Each user that desires these authentication services is provided a “token” 205 by the verifier 107. For the purpose of this document, the term “token” refers to any device that is capable of generating a value that is uniquely associated with the user and cannot, in any practical manner, be recreated by anyone else except possibly the verifier 107. Each individual token may have a corresponding token ID, which is simply some alphanumeric identifier that the verifier 107 can use to distinguish among the several tokens that it distributes.

In one particular implementation, the token 205 is a portable device configured with an algorithm that produces a unique value based on a combination of the current time and a cryptographic key. The cryptographic key is a static value of predetermined length that is generated in such a manner as to be unique to some degree of confidence. Although true “uniqueness” using a finite value may be impossible, the larger the cryptographic key, the greater the degree of confidence that it is indeed universally unique. In one embodiment, the token 205 can either be pre-configured with a cryptographic key by the verifier 107, or a cryptographic key embedded within the token 205 can be made known to the verifier 107. Tokens are known in the art.

The verifier 107 includes a user data store 211 that identifies each user. More specifically, each user has a corresponding entry in the user data store 211 that includes information sufficient to identify the user and to authenticate the user. In this example, the user data store 211 includes a user entry 213 for the customer 105 (FIG. 1). This example user entry 213 includes the customer's name, an identifier for the particular token provided to the customer, a shared secret, and perhaps other miscellaneous information. In this particular implementation, the shared secret stored in the user entry 213 is a copy of the cryptographic key (or a corresponding cryptographic key) embedded within the customer's token 205. The miscellaneous information could include, for example, a listing of those providers for which the customer has authorized authentication.

The verifier 107 also includes a verification engine 217, which further includes a value generator 218 and, in this implementation, a clock 219. The value generator 218 also uses an algorithm to generate a unique value based on a cryptographic key in combination with the current time. The verification engine 217 is configured so that it will generate the same unique value as the token 205 at the same time, which means that the verification engine 217 must provide to the value generator 218 the same (or a corresponding) cryptographic key as is used by the token 205. Accordingly, accordingly, to generate the same unique value as the customer's token 205, the verification engine 217 retrieves the customer's shared secret (e.g., the cryptographic key) from the customer's user entry 213 and provides it to the value generator 218. In addition, the clock 219 should be synchronized with the internal clock mechanism of the token 205. Given that the value calculation is based on time, the unique value generated by both the token 205 and the verification engine 217 will change over time. In some cases, the unique value may change as often as every minute or so.

Finally, the verifier 107 may include provider data 225 that specifies which providers the verifier 107 has a relationship with, meaning which providers are authorized to request verification information from the verifier 107. In addition, the provider data 225 may include information about how to communicate with each of the particular providers, and perhaps even a list of the particular users each provider is authorized to request verification for. Other information about the relationships with providers may also be included, as will be apparent to those skilled in the art.

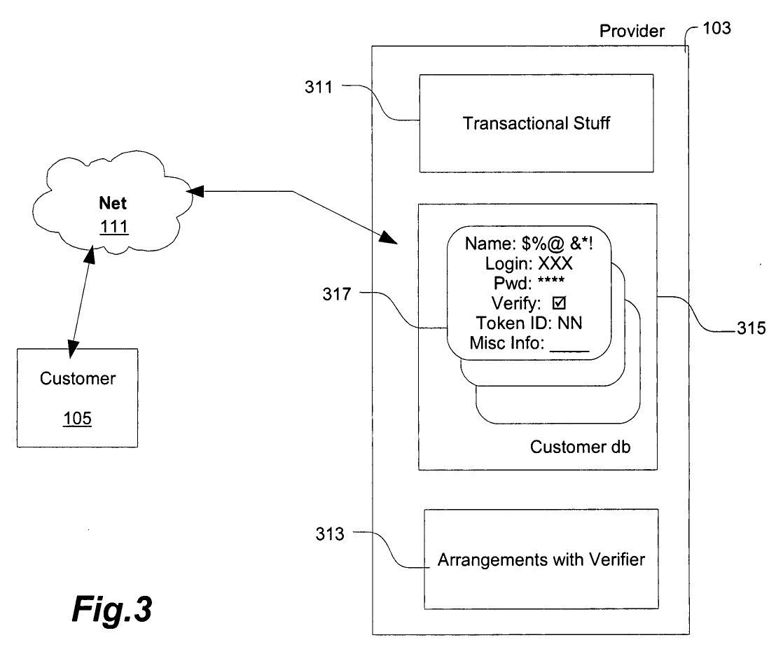

FIG. 3 is a functional block diagram illustrating in slightly greater detail one implementation of the provider 103. In this implementation, the provider 103 is any entity or individual that desires to authenticate the identity of customers. There may be any number of examples, but by way of illustration consider that the provider 103 is an online merchant or the like that provides services or goods over the network 111. Customers, such as customer 105, connect to the provider 103 over the network 111 and conduct transactions of a nature that justifies verifying the identity of the customers. The provider 103 could provide online sales of goods and/or services (e.g., “Amazon.com”), facilitate online transactions with other customers (e.g., “eBay.com”), provide online financial services (e.g., “IngDirect.com”), provide a forum for individuals to discuss hobbies (e.g., “UFC.tv” or “MMAWeekly.com”), provide access to a corporate network, any combination of these, or the like.

The provider 103 includes transactional information 311 used in the provider's primary endeavor. For example, if the provider 103 is an online merchant, the information 311 could include lists of inventory, pricing data, purchasing history, and the like. In addition, the provider 103 may include verifier information 313. The verifier information 313 may include data that identifies how the provider should contact one or more particular verifiers, such as verifier 107, to request an identity verification. The verifier information 313 may include identifiers and electronic addresses (e.g., URLs or URls) for the verifier(s), protocols to use to communicate with the verifier(s), message structure and format, and perhaps even data schema for constructing appropriate communications with the verifier(s). These are but examples and alternatives will become apparent to those skilled in the art.

The provider 103 also includes a customer database 315 with records for each customer that is entitled to remote access to the provider 103. For example, record 317 is associated with customer 105. The record 317 may include various data, but likely includes at least a name for the customer 105 and a login identifier. In many instances the login identifier may be an arbitrary alphanumeric string, such as an e-mail address, a sequence of letters and numbers, or any other identifier. The record 317 also includes a token identifier, which could be the same as the login identifier (e.g., an e-mail address or the like) or it could be some other value, such as a particular token identifier provide to the customer 105 by the verifier 107. In summary, the login identifier is used by the customer to identify himself/itself to the provider, while the token identifier is used by the provider to identify the customer 105 to the verifier 107. The two values could be, but need not necessarily be the same.

In this implementation, the record 317 also includes a password for the customer 105, although in other implementations this may be unnecessary. For example, as will be described in greater detail later, the provider 103 could prompt the customer 105 for only the customer's login identifier and the current token value. Alternatively, the provider 103 could also prompt the customer for a password.

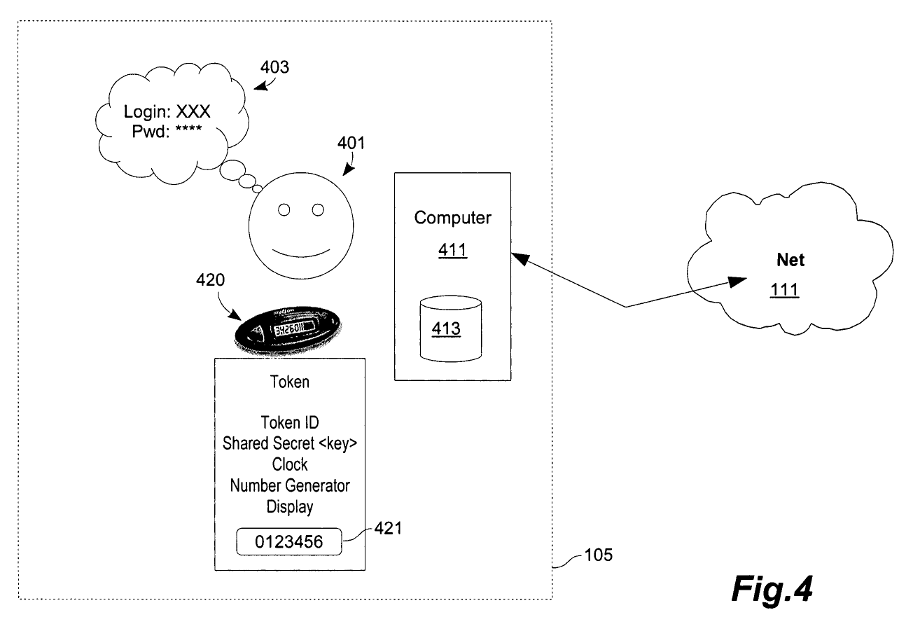

FIG. 4 is a functional block diagram illustrating in slightly greater detail one implementation of the customer 105. In most examples, the customer 105 will simply be an individual 401 who maintains information, such as the customer's login identifier and perhaps password, in the individuals memory 403. However, in some cases, the customer 105 could in fact be a computing system 411 with persistent storage 413 on which is stored information, such as the login identifier and perhaps password. For example, the customer 105 could be a non-human entity, such as a corporation or the like, with an account at the provider 103.

Importantly, the customer 105 is in possession of the token 420 provided by the verifier 107. As mentioned above, the token 420 includes a token ID, a shared secret (e.g., a cryptographic key), and a token value generator. The token value generator generates a unique token value 421 based on at least the shared secret and, perhaps, the current time. The token 420 also includes a display for displaying the current token value 421. Often the token includes a button or the like that is pressed to generate and display a current token value 421. The current token value is usually valid only for a brief period of time, such as one or two minutes.

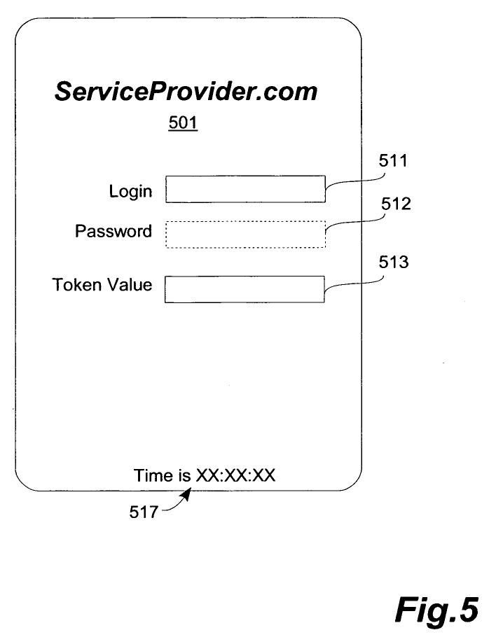

FIG. 5 is a conceptual illustration of a login page 501 that may be presented to the customer by the provider. The login page 501 may prompt the customer to enter at least a login identifier 511 and the current token value 513 from the customer's token. With this information alone, the provider could request a verification of the customer from the verifier. However, the login page 501 will likely include a prompt for a password 512 as well, such as for customers that do not use central identity verification, or if the provider or customer would simply like an additional level of security. Thus, in summary, the customer is presented with the login page 501 through which the provider collects at least a login identifier 511 and a current token value 513, which may be based on the current time 517. The login page 501 may also be used to collect a password 512.

Although illustrated here as an actual page that is presented to the customer, it will be appreciated that the login page 501 could be replaced with a programmatic mechanism for collecting the same information. For example, in cases where the customer is in fact merely a computing system, it may be unnecessary to use a login page that is capable of visible representation. Rather, a structured protocol for providing the same information in electronic message format could be used. Other alternatives are also possible.

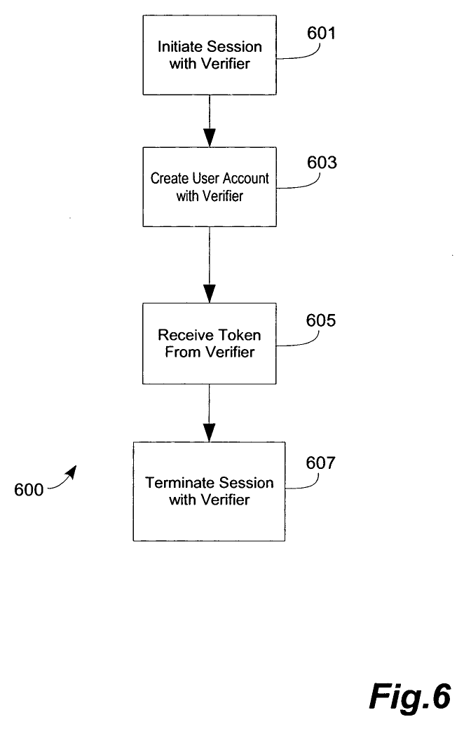

The processes illustrated in FIGS. 6 through 9 will be described here in the general context of computer-executable instructions, such as program modules, executed by one or more computers or other devices. Generally, program modules include routines, programs, objects, components, data structures, and the like that perform particular tasks or implement particular abstract data types. Typically, the functionality of the program modules may be combined or distributed as desired in various embodiments, and in various orders. Accordingly, no specific importance should be assigned to the particular order of description of the processes nor to the particular groupings of functionalities described in each step of each process.

FIG. 6 is an operational flow diagram generally illustrating a process 600 performed by a customer to register himself/itself with a centralized identity verifier. The process 600 begins at step 601 where the customer approaches the verifier and initiates a session. Initiating the session could be starting an online session at a Web presence hosted by the verifier, or initiating the session could be simply a telephone call from the customer to a representative of the verifier. There are many possible alternatives for initiating the session.

At step 603, a user account is created for the customer with the central identity verifier. The user account is used by the verifier to maintain information about the verifier's users (e.g., customer). The user account includes, at least, a user identifier for the user account and may also include any arbitrary additional information, such as a name and contact information for the user (e.g., customer).

At step 605, a token is received by the customer from the verifier. The token is a device that is configured to generate, in this implementation, a different random value on a periodic basis. The token is associated by the verifier with the user identifier so that the verifier can determine which user is in possession of which token.

At step 607, the session with the central identity verifier is terminated. At this point, the customer has created a user account with the verifier and received a token that is associated with the customer's user account.

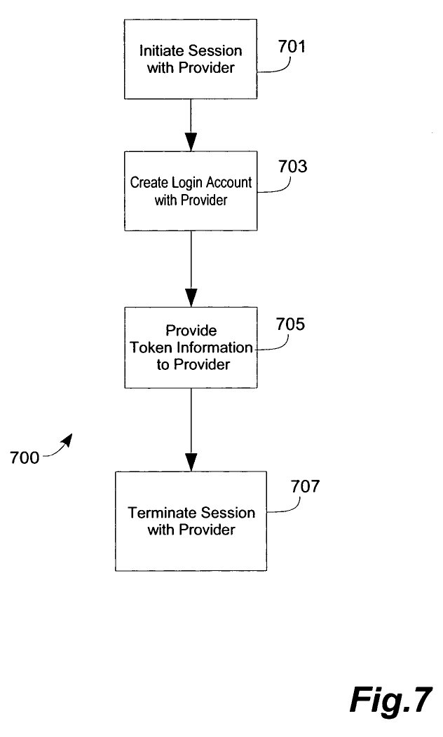

FIG. 7 is an operational flow diagram generally illustrating a process 700 performed by a customer to register himself/itself with the provider. The process 700 begins at step 701, where a session is initiated with a provider. As with the process 600 discussed above, initiating the session could be starting an online session at a Web presence hosted by the provider, or initiating the session could be simply a telephone call from the customer to a representative of the provider. There are many possible alternatives for initiating the session.

At step 703, a login account is created with the provider. The login account provides the customer access to functionality (e.g., goods or services) offered by the provider. Commonly, the login account includes a login name and perhaps a password or other authentication credentials that the customer must use to gain access to the login account. In some cases, an e-mail address or the like can be used as the login name. The password may be optional, such as in the case where a token value will be used to authenticate the user's login name.

At step 705, token information is also given to the provider either in conjunction with creating the login account or at any later time, such as during a subsequent login session. The token information includes at least an identifier for a token in the possession of the customer. The token identifier could, possibly, be the same as the customer's login name. Alternatively, the token identifier could be some arbitrary value assigned to the token in the customer's possession.

At step 707, the session with the provider is terminated. It should be noted that this step need not necessarily be performed after the token information is given to the provider, such as the case where the token information is given during a subsequent session. This step relates merely to the termination of the login account creation session.

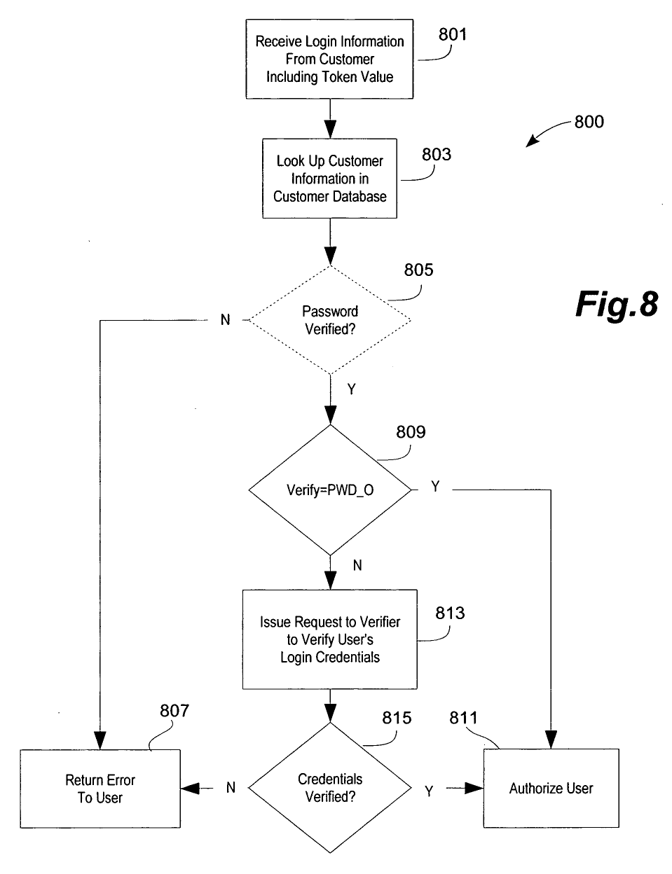

FIG. 8 is an operational flow diagram generally illustrating a process 800 performed by a provider to have the identity of a customer verified by a verifier. The process 800 begins at step 801, where a customer of the provider is attempting to initiate a login session with the provider, such as by logging in at a Web presence operated by the provider. Alternatively, the customer could be attempting to perform a transaction in person, such as at a bank teller's window. The process 800 begins at step 801.

At step 801, a login request is received from the customer. The request includes login credentials provided by the customer. The login credentials include at least a user login name and a token value, and may additionally include a password. The login credentials purport to attest to the customer's identity.

At step 803, customer information associated with the login credentials is retrieved to identify the customer. For example, the provider may retrieve information stored in association with the login name provided by the customer. The customer information further includes other information that can be used to authenticate the login credentials provided by the customer. For example, the customer information may include a stored password associated with the login name provided by the

At step 805, a determination is made whether a password provided in the login credentials matches a stored version of the password. It should be noted that this step is option if the provider has opted to verify the customer's identity with only a token value and not a password. If a password is required, and the password provided by the customer did not match the stored password, the process 800 proceeds to step 807, described below. Otherwise, the process continues at step 809.

At step 809, a determination is made whether the customer's identity may be verified by only a password of if a token should be used. This determination could be active, such as by querying data in the customer's account records, or passive, such as the case where all customers are verified using tokens. If the customer's identity can be verified by password only, then the process continues at step 811, described below. Otherwise, the process 800 continues at step 813.

At step 813, a verification request is issued to a central identity verifier to verify the login credentials. The verification request includes the token value provided by the customer. The verification request additionally includes an identifier for the customer that the provider and the verifier have previously agreed to use to identify the customer. For example, the provider may request the verifier to verify that the customer attempting to login with a certain login name is indeed the individual or entity authorized to use that login name. The verifier confirms that the token value provided by the customer could only have been generated by the token that the verifier provided to the customer, thus confirming the identity of the customer.

At step 807, the customer's login credentials did not verify the customer's identity, and thus an error is returned to the customer. Perhaps the customer's attempt to login is simply denied, or perhaps the customer is prompted for new login credentials.

At step 811, the customer's login credentials successfully verified the customer's identity, and the customer becomes authorized to perform a transaction with the provider.

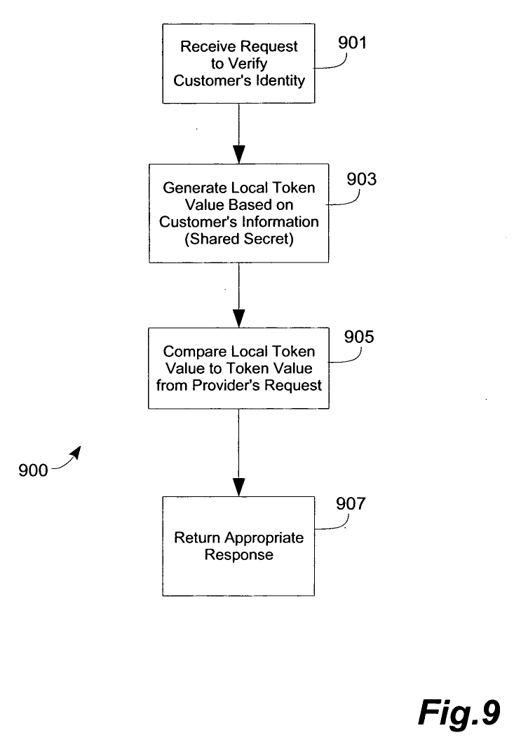

FIG. 9 is an operational flow diagram generally illustrating a process 900 for verifying the identity of a customer in response to a request by a provider. The process 900 begins when a customer attempts to initiate a login session with a provider using certain login credentials. Those login credentials include a customer identifier, such as a login name, and at least a remote token value which corresponds to a value displayed on the customer's token at the time the customer is attempting to log in. The login credentials may additionally include other information, such as a password.

At step 901, a verification request is received by the verifier from the provider. The provider is requesting verification of the identity of the customer. The verification request includes at least the remote token value and a user identifier. The user identifier could be the login name of the customer, or any other identifier that the provider and the verifier agree to use to distinguish the customer from other users of the verifier's service.

At step 903, a local token value is generated based on local information about the customer. For example, the verifier may maintain records that allow the verifier to produce a token value based on a secret shared between the verifier and the customer's token, such as a cryptographic key, or the like. The local information used to generate the local token value would include that shared secret. The local information may also be indexed based on the user identifier, which could be an e-mail address, login name, token ID number, or the like.

At step 905, the local token value is compared with the remote token value, which could be a simple mathematical comparison done programmatically. Alternatively, the comparison could even be performed manually, although the latency introduced by a manual comparison may present a usability problem.

At step 907, an appropriate response is returned to the provider based on the comparison of the local token value to the remote token value. For example, if the comparison revealed that the local token value matched the remote token value, the verifier may simply return a confirmation or acknowledgment to the provider. If the local token value and the remote token value do not match, the verifier could return an error or request that the provider prompt the customer for a new token value.

The verifier may request a new token value, for example, simply to give the customer another attempt at logging in. In addition, the time between the customer providing the first remote token value and the verifier generating the local token value could have exceeded the lifetime of the remote token value, such as could be the case with a high-latency or low-bandwidth network.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A method for having an identity of a customer verified, comprising, in no particular order, the steps of:
receiving a login request from the customer, the request including login credentials provided by the customer, the login credentials being used to attest to an identity of the customer;
looking up customer information associated with the login credentials;
issuing a verification request to a central identity verifier to verify the login credentials, the verification request including a token value provided by the customer in the login request; and
if verified by the central identity verifier, performing a transaction with the customer.

2. The method recited in claim 1, wherein the token value is generated by a token that is configured to periodically generate arbitrary token values using a technique which may be duplicated by the central identity verifier.

3. A computer-readable medium encoded with computer-executable instructions for performing the method recited in claim 1.

4. A method for verifying an identity of a customer, comprising, in no particular order, the steps of:
receiving a first verification request from a provider to verify the identity of the customer, the first verification request including a remote token value provided by the customer to the provider;
generating a local token value based on local information about the customer;
comparing the local token value with the remote token value; and
returning an appropriate response to the provider based on the comparison of the local token value to the remote token value.

5. The method recited in claim 4, further comprising the step of repeating the method for a different customer.

6. A computer-readable medium encoded with computer-executable instructions for performing the method recited in claim 4.

7. A method for creating a customer account, comprising, in no particular order, the steps of:
initiating a session with a provider;
creating a login account with the provider;
providing token information to the provider during a login session; and
terminating the session with the provider.

8. A computer-readable medium encoded with computer-executable instructions for performing the method recited in claim 7.

9. A method for creating an account with a centralized identity verifier, comprising, in no particular order, the steps of:
initiating a session with the central identity verifier;
creating a user account with the central identity verifier, the user account including a user identifier for the user account;
receiving a token from the verifier, the token being configured to generate a different random value on a periodic basis, the token being associated with the user identifier; and
terminating the session with the central identity verifier.

10. A computer-readable medium encoded with computer-executable instructions for performing the method recited in claim 9.
